(19) United States
(12) Patent Application Publication
(10) Pub. No.: US 2005/0251564 A1
(43) Pub. Date: Nov. 10, 2005

(54) Remote instrument control by multiple clients

(76) Inventors: Timothy Nephi Tillotson, Heber, UT (US); Sara Ting, Cupertino, CA (US); Byron T. Jenings JR., Loveland, CO (US); Nathan A. Berg, Fort Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/825,465

(22) Filed: Apr. 15, 2004

(51) Int. Cl. G06F 15/16

(52) U.S. Cl. 709/218

(57) ABSTRACT

Method and apparatus for remotely controlling an instrument. In representative embodiments, at least one communication is received from each of at least two clients, wherein each received communication conforms to a client specific protocol. It is determined from which client each received communication was received. An application resident on the instrument for which each received communication is intended is determined, wherein at least one application is resident on the instrument. And each received communication is transferred to the intended application.

### BACKGROUND

Initially, electronic instruments were stand-alone units designed for rather limited and specific applications. Within the instrument industry, a wide variety of instrument command sets were developed which required instrument users to learn a new vocabulary for each instrument. This proliferation of command sets resulted in users spending a great deal of time learning how to program instruments, made maintenance of test programs difficult, and made it difficult to upgrade test systems as new equipment became available. In order to reduce development costs, various standard electrical and mechanical interfaces were developed for instruments and other electronic devices. With the advent of computer communication with and computer control of instruments and systems of instruments, standardized signal protocols and other standardized electrical and mechanical interfaces became more prevalent. These protocols were mainly intended to set standards for digital messages sent over these interfaces.

The Standard Commands for Programmable Instrumentation (SCPI) protocol standard was developed to define a set of commands for controlling programmable test and measurement devices in instrumentation systems. An instrumentation system is a collection of test and measurement devices connected by a communication bus to a control computer called the system controller. An instrumentation system may include stand-alone devices like IEEE 488 instruments or instrument cards in an enclosure such as a VXIbus rack.

Client processes often located on remote computers address commands, which may be, for example, a command to apply a signal, make a measurement, perform a calibration, or the like to one or more instruments over the bus. These commands are called program messages. Instruments may also send response messages back to the clients. The response messages may be measurement results, instrument settings, error messages, or the like. Prior to the SCPI standard, the commands that controlled a particular device function varied between instruments which had similar capabilities. SCPI provided a uniform and consistent language for the control of test and measurement instruments. The same commands and responses can control corresponding instrument functions in SCPI equipment, regardless of the supplier or the type of instrument.

For instance, the command to measure a frequency is the same whether the measurement is made by an oscilloscope or a counter. The set of commands to control multimeters from two manufacturers differs only in places where the underlying hardware has different capabilities. Thus, instruments from different vendors can be expected to be essentially interchangeable in many applications.

SCPI provides a means to perform simple operations. The MEAS (measure) command, for example, can configure and read data from an instrument. When the program message “:MEAS:VOLT:AC?” is received by a voltmeter, for example. the meter will select settings and configure its circuitry for an AC voltage measurement, initiate the measurement, and return the result to the system controller. The question mark at the end of the command instructs the voltmeter to return the measured value to the controller. As another example, the SCPI command “:MEAS:FREQ?” returns a frequency measurement from an oscilloscope or a counter, despite great internal differences in the hardware of the instruments.

SCPI commands are organized in hierarchical structures referred to as trees. In the above two commands, “MEAS” is a parent node in a SCPI tree while “VOLT” is one child node of that parent and “FREQ” is another child node.

A central feature of the SCPI standard is the Command Reference which is a list of definitions for all the program messages. These definitions specify precisely the syntax and semantics for every SCPI message. Instrument functions covered by the standard may only be controlled through SCPI commands. However, SCPI was designed with a modular structure that permits commands controlling new functions to be added at any time.

The Hewlett-Packard Interface Bus (HPIB) interface system, also known as the General-Purpose Interface Bus (GPIB) or by its Institute of Electrical and Electronic Engineers (IEEE) specification number, IEEE 488 is a scheme by which groups of devices may be connected to a controlling computer and communicate under its direction. Instruments from multiple vendors can be operated in the same HPIB system. SCPI commands can be implemented on an instrument using any sort of interface, as for example, HPIB, serial/RS-232, VXI backplane, or the like, but they are especially common on HPIB busses.

The IEEE 488.1 standard defines hardware for an instrumentation bus. This instrumentation bus is a digital bus with lines for the serial transfer of data bytes, plus extra control and handshaking lines. The IEEE 488.2 standard is an additional standard that defines protocols for data/command exchange between controller and instruments, basic data formats, systematic rules for program messages, and definition of instrument status structures. IEEE 488.2 also defines some common commands covering instrument functions that are universally applicable. However, IEEE 488.2 does not define commands or data structures for specific applications. Instrument makers are free to define the commands that control the primary functions of their instruments. SCPI builds upon IEEE 488.2 by standardizing these primary functions.

.NET is an open software standard initially developed by Microsoft which is becoming more and more popular for use in developing applications for instruments and instrument systems in the test and measurement field. Since a large majority of test and measurement instruments and systems are connected to one or more computers and since NET was developed primarily for use with computer controlled applications, .NET has become a standard development platform for instruments and instrument systems. As such, NET may well eventually replace SCPI as the application language of choice in a large number of instruments and instrument systems.

### SUMMARY

In representative embodiments, methods and apparatus for remotely controlling an instrument are disclosed. In one representative embodiment, at least one communication is received from each of at least two clients, wherein each received communication conforms to a client specific protocol. It is determined from which client each received communication was received. An application resident on the instrument for which each received communication is intended is determined, wherein at least one application is resident on the instrument. And each received communication is transferred to the intended application.

In another representative embodiment, an instrument, comprises at least two server logic modules, at least one interpreter logic module, and at least one application module resident on the instrument. Each server logic module is configured to receive communications from separate client logic modules, each received communication conforms to a client specific protocol of the client logic module from which the received communication was transmitted, and each server logic module is configured to determine from which client the received communications were transmitted. The interpreter logic module is configured for formatting the received communications. Each server logic module is connected to and transfers its received communications to one of the interpreter logic modules, and each interpreter logic module is configured to format the received communications from the server logic modules to a format in which its intended application can respond. Each server logic module is configured to determine for which application each received communication is intended, and each interpreter logic module is configured to transfer the interpreter logic module formatted communications to the intended application.

Other aspects and advantages will become apparent from the following detailed description, taken in conjunction with the accompanying drawings, illustrating by way of example the principles of the representative embodiments.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a block diagram of a measurement system as described in various representative embodiments.

FIG. 2 is a block diagram of an embodiment of part of the measurement system of FIG. 1.

FIG. 3 is a block diagram of an alternative embodiment of part of the measurement system of FIG. 1.

FIG. 4 is a block diagram of another alternative embodiment of part of the measurement system of FIG. 1.

FIG. 5 is a drawing of a flow chart of a method for remote control of an instrument by multiple clients as described in various representative embodiments.

FIG. 6 is a drawing of a flow chart of another method for remote control of an instrument by multiple clients as described in various representative embodiments.

### DETAILED DESCRIPTION

As shown in the drawings for purposes of illustration, the present patent document relates to novel techniques for enabling the ability to share the usage of an instrument. In representative embodiments, a measurement system can comprise multiple concurrent SCPI observers (clients) of an instrument and a single instrument controller. A single client with security permissions can become the instrument controller, thereby locking control of the instrument so that the other clients may only be observers. In other embodiments, multiple clients can share and collaborate for use and access of the instrument. And in still other embodiments, clients with different security permissions and privileges can collaborate and share the instrument as allowed by specified privileges and permissions. Such collaboration includes GPIB and SCPI commands/queries, device synchronization, and the SCPI status system.

While the representative embodiments disclosed herein are presented in terms of SCPI clients, the methods are not limited to such frameworks and protocols. Other protocols, for example NET which is an open software standard initially developed by Microsoft, Sun Microsystems' Java, CORBA which is a standard of the Object Management Group (OMG), or the like, could be used.

In the following detailed description and in the several figures of the drawings, like elements are identified with like reference numerals.

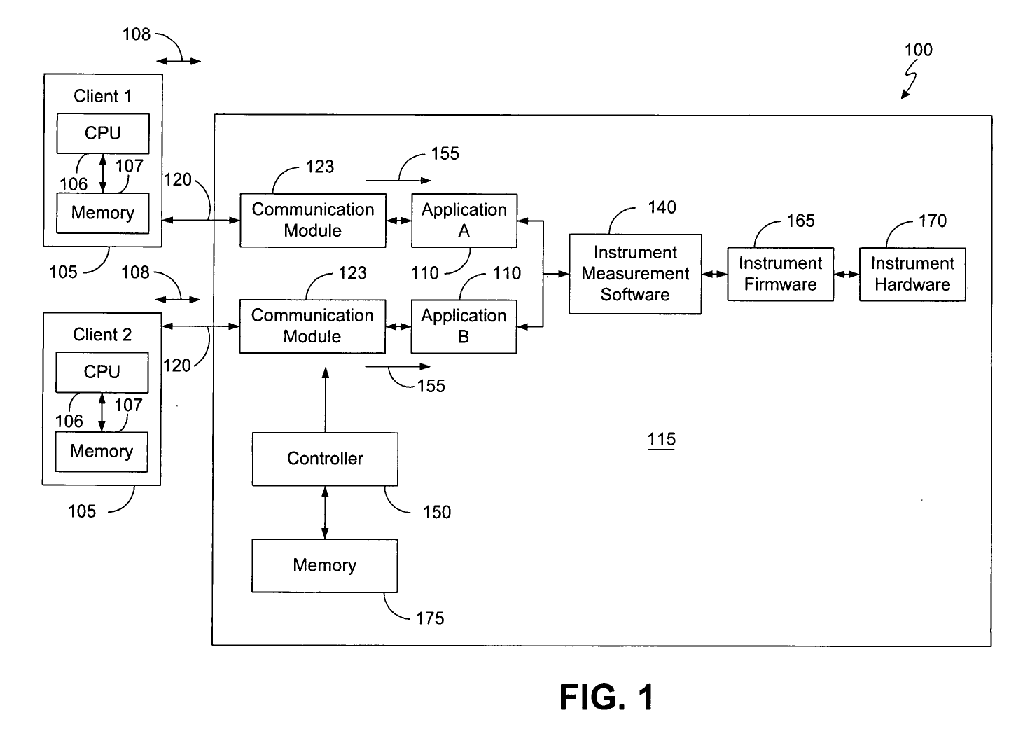

FIG. 1 is a block diagram of a measurement system 100 as described in various representative embodiments. In the embodiment of FIG. 1, two clients 105 (client 1 and client 2) are each separately connected to two applications 110 (application A and application B), also referred to herein as application modules 110 and application logic modules 110, on an instrument 115 by means of communication links 120 and communication modules 123, also referred to herein as communication logic modules 123. Each of the clients 105 sends communications 108 to and receives communications 108 from its associated application 110 on the instrument 115 by means of communication links 120 and communication modules 123.

The clients 105 typically comprise a central processing unit (CPU) 106 or other control module 106 and a memory 107, also referred to herein as a memory module 107. Under control of a controller module 150, also referred to herein as a controller logic module 150, which is connected to another memory 175, again referred to as memory module 175, communications 108 to and from the instrument application 110.

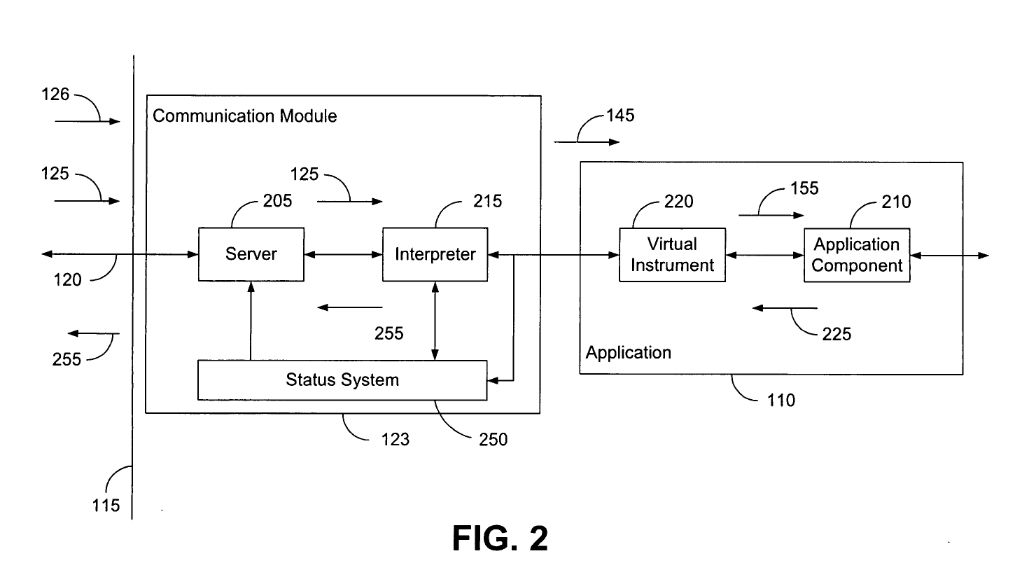

Communications 108 controlling the functioning of the instrument 115 are generically referred to as remote procedure control (RPC) commands 125 and herein as commands 125 (see FIG. 2). Before transmission RPC commands 125 are typically formatted by the client 105 into a SCPI protocol command 125. A number of standard sets of program calls or routines referred to as Application Program(ming) Interface (API) functions are used to control various applications on the instrument 115. The set of API functions which the application 110 on the instrument 115 has been programmed to understand are written using RPC functions or commands 125 which are resident on the instrument 115 and which are referred to as the instrument resident or instrument native API's. Similarly, the format or grammar used to write these API's is referred to as the native language of the instrument 115. The instrument native API's are formatted in conformance to an application specific protocol. In order to control the instrument 115, commands 125 reaching instrument measurement software 140 need to conform to the application specific protocol.

In a representative embodiment, the application 110 sends instructions to the instrument measurement software 140 which in turn transfers these instructions to instrument firmware 165. The instrument firmware 165 finally transfers the required instructions to instrument hardware 170 for performing the requested task.

Standard communication protocols are used in various industries. Standard Commands for Programmable Instruments (SCPI) is one such protocol commonly used in the Test and Measurement industry. SCPI comprises a common set of commands that instruments of a particular type will understand. For example, as a general rule, voltmeters and spectrum analyzers will understand particular sets of SCPI commands which control various functions on these instruments. Instrument functionality varies depending upon instrument manufacturer and type. Product differentiation is enhanced by the manufacturer by the addition of various capabilities to the instrument. SCPI is coded as an ASCII string and has a hierarchical command structure. At the top level could be an instruction to select the general function to perform, such as measure or calibrate a subsystem or system sub-system. The next level could be a more specific statement of what the function is to perform, for example measure a frequency, voltage, or current in the item selected for measurement. Under voltage, for example, might be the type of voltage, i.e., DC voltage (direct current voltage) or AC voltage (alternating current voltage). A command might be “Measure voltage DC”. Each of these items “Measure”, “Voltage” and “DC” are considered to be a SCPI node. The collection of all SCPI nodes in an instrument is a SCPI tree. In the instrument capable of deciphering SCPI grammar, a SCPI parser waits and listens for a SCPI command. When the SCPI parser receives a SCPI command that it understands, it identifies the correct SCPI node that corresponds to the SCPI command and instructs that node to perform the requested function.

However, not all instruments use SCPI for their resident command language API's, and computers used in the control of instruments do not always use a SCPI command set. There are potentially several different command languages that the computer can communicate with an instrument. In addition to SCPI, a computer or system could use NET which is an open software standard initially developed by Microsoft, Sun Microsystems' Java, CORBA which is a standard of the Object Management Group (OMG), or the like.

FIG. 2 is a block diagram of an embodiment of part of the measurement system 100 of FIG. 1. In the embodiment of FIG. 2, the communication module 123 comprises a server module 205, also referred to herein as a server logic module 205, an interpreter 215, also referred to herein as a interpreter module 215 and as a interpreter logic module 215, and a status system 250. The server module 205 receives commands 125 from its associated client 105 and transfers those commands to the interpreter module 215. The interpreter module 215 interprets the commands 125 from the associated client 105, which commands 125 have a client specific protocol, into an interpreted command 145 usable by the application module 110.

The application module 110 comprises a virtual instrument module 220, also referred to herein as a virtual instrument 220, a virtual instrument logic module 220, an interface 220, an interface module 220, and an interface logic module 220, and an application component module 210, also referred to herein as an application component 210 and an application component logic module 210. The virtual instrument module 220 acts as an interface to the application component module 210. It receives the interpreted command 145 at the input of the virtual instrument 220 and acts as an interface to control the flow of communications 108 between the client 105 and its associated application component 210. If necessary, the virtual instrument module 220 may provide further modification of the interpreted command 145. This modified interpreted command 145 is shown in the figures as application command 155. The application component module 210 connects to the instrument measurement software 140.

Another form of client-application communications 108 are messages 225 which are also referred to herein as application messages 225. Messages 225 can be sent from the application component module 110 to the associated client 105. The messages 225 are transferred from the application component 210 to the virtual instrument 220 which in turn transfers them to the interpreter 215 in the communication module 123.

The interpreter 215 modifies the messages 225 to produce client messages 255 which are in appropriate format for the client 105. The interpreter 215 then transfers the client messages 255 to the server 205. The server 205 then transmits the client messages 255 to the appropriate client 105. Such transmission may include breaking the client message 105 into one or more packets and wrapping these packets with appropriate code for routing the packets to the appropriate client 105 and subsequent reformation of the client message 255 by the client 105.

Alternatively, clients 105 can be notified of events occurring on the application component 210 via the posting of such information by the application 110 to the status system 250 and a subsequent asynchronous notification sent to the client 105. Upon receipt of a query 126 which is another form of communication 108 from the client 105 and which is a request for information from the instrument 115, additional information regarding the event that is obtained from the status system 250 can be transmitted by the server 205 to the client 105.

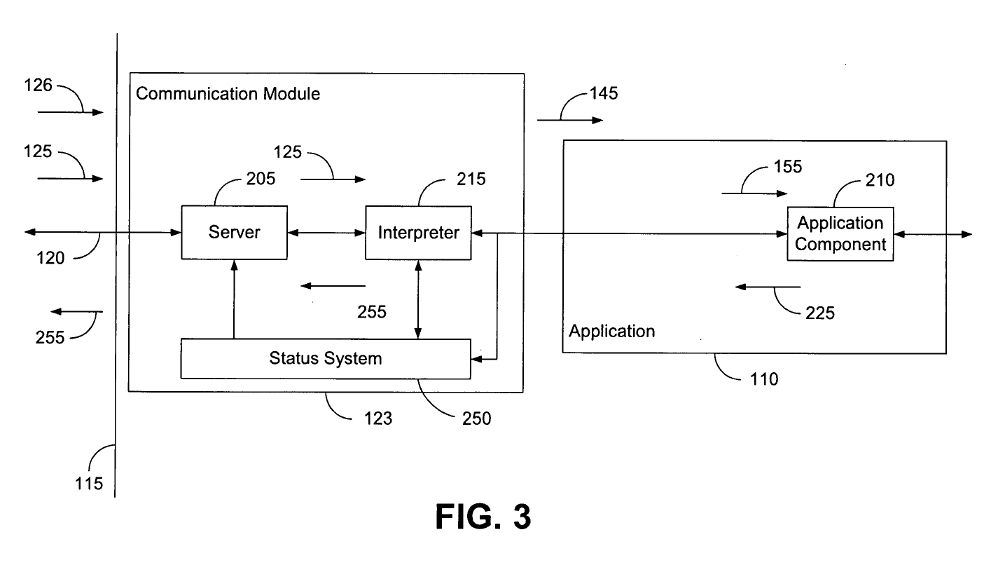

FIG. 3 is a block diagram of an alternative embodiment of part of the measurement system 100 of FIG. 1. In the embodiment of FIG. 3, the communication module 123 comprises the server module 205, the interpreter 215, and the status system 250. The server module 205 receives commands 125 from its associated client 105 and transfers those commands to the interpreter module 215. The interpreter module 215 interprets the commands 125 from the associated client 105, which commands 125 have the client specific protocol, into the interpreted command 145 usable by the application module 110. The application module 110 comprises the application component module 210. The application component module 210 connects to the instrument measurement software 140.

Messages 225 can be sent from the application component module 210 to the associated client 105. The messages 225 are transferred from the application component 210 to the interpreter 215 in the communication module 123.

The interpreter 215 modifies the messages 225 to produce client messages 255 which are in appropriate format for the client 105. The interpreter 215 then transfers the client messages 255 to the server 205. The server 205 then transmits the client messages 255 to the appropriate client 105. Such transmission may include breaking the client message 225 into one or more packets and wrapping these packets with appropriate code for routing the packets to the appropriate client 105 and subsequent reformation of the client message 255 by the client 105.

Alternatively, clients 105 can be notified of events occurring on the application component 210 via the posting of such information by the application 110 to the status system 250 and a subsequent asynchronous notification sent to the client 105. Upon receipt of a query 126 which is another form of communication 108 from the client 105 and which is a request for information from the instrument 115, additional information regarding the event that is obtained from the status system 250 can be transmitted by the server 205 to the client 105.

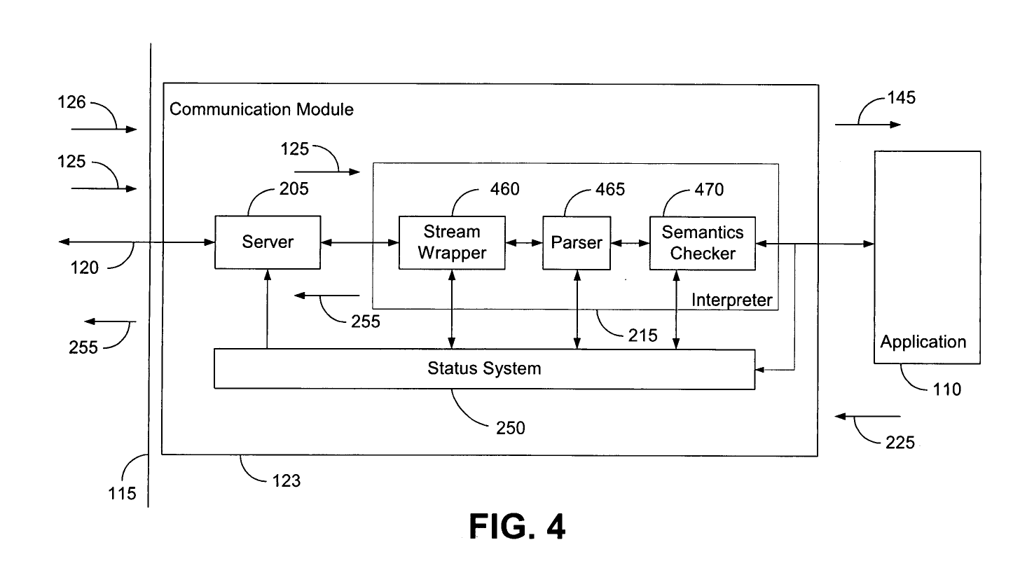

FIG. 4 is a block diagram of another alternative embodiment of part of the measurement system 100 of FIG. 1. In the embodiment of FIG. 4, the communication module 123 comprises the server module 205, the interpreter 215, and the status system 250. The server module 205 receives commands 125 from its associated client 105 and transfers those commands to the interpreter module 215. The interpreter module 215 interprets the commands 125 from the associated client 105, which commands 125 have the client specific protocol, into the interpreted command 145 usable by the application module 110.

In the embodiment of FIG. 4, the interpreter module 215 comprises a stream wrapper 460, also referred to herein as a stream wrapper module 460 and as a stream wrapper logic module 460, a parser 465, also referred to herein as a parser module 465 and as a parser logic module 465, and a semantics checker 470, also referred to herein as a semantics checker module 470 and as a semantics checker logic module 470.

In a representative embodiment, servers 205 can be input/output (I/O) drivers 205 which are essentially kernel drivers to control a GPIB card, USB hardware, or the like. In the alternative embodiment of FIG. 4, the typically SCPI communications 108 can be modified by the stream wrapper 460 to place the communication 108 in a format more usable by other protocols as, for example, the .NET protocol. In this way, the I/O drivers 205 can be made to look like NET class of objects.

The parser 465 parses the commands 125 received from the stream wrapper 460 which are typically SCPI ASCII commands 125 which it needs to put into a format usable by the application 110. Such actions by the application 110 might be, for example, “set an instrument setting variable”, “retrieve and instrument setting”, or “execute an instrument functionality”. The parser 465 acts as an intermediary between the SCPI ASCII commands 125 and the internal instrument 115 application 110. The status system 250 is an error/event notification system.

The semantics checker 470 checks items in the communications 108 such as the range of the measurement to be made or the value of the measurement taken. If either of these parameters are out of an acceptable range, the semantics checker 470 will report to the status system 250 that an out of limit error has been detected.

Not all commands will flow through all components of the interpreter 215. If the stream wrapper 460, the parser 465, or the semantics checker 470 detects an error, the status system 250 will be informed that an error has been detected and what that error is. In another example, if the instrument 115 is out of calibration that event will also be reported to the status system 250.

In representative embodiments, various components of the communication module 123, including but not limited to, the server 205, the interpreter 215, the stream wrapper 460, the parser 465, the semantics checker 470, and the status system 250 can be shared by more than one client 105 and/or by more than one application 110.

Messages 225 can be sent from the application 110 to the associated client 105. The messages 225 are transferred from the application 110 to the semantics checker 470 in the interpreter 215 in the communication module 123.

The components of the interpreter 215 modify the messages 225 to produce client messages 255 which are in appropriate format for the client. The interpreter 215 then transfers the client messages 255 to the server 205. The server 205 then transmits the client messages 255 to the appropriate client 105. Such transmission may include breaking the client message 225 into one or more packets and wrapping these packets with appropriate code for routing the packets to the appropriate client 105 and subsequent reformation of the client message 255 by the client 105.

Alternatively, clients 105 can be notified of events occurring on the application component 210 via the posting of such information by the application 110 to the status system 250 and a subsequent asynchronous notification sent to the client 105. Upon receipt of a query 126 which is another form of communication 108 from the client 105 and which is a request for information from the instrument 115, additional information regarding the event which is obtained from the status system 250 can be transmitted by the server 205 to the client 105.

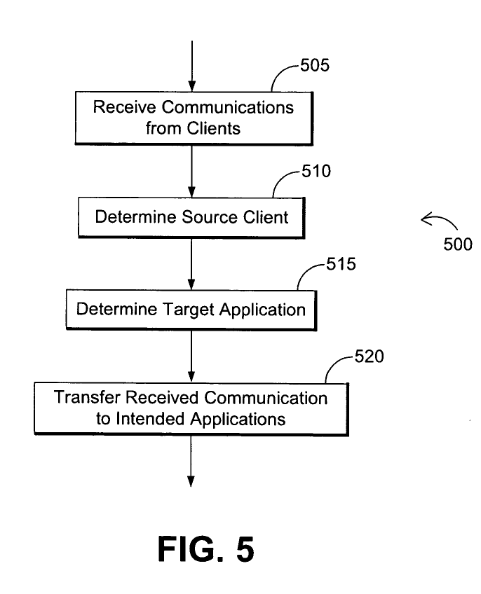

FIG. 5 is a drawing of a flow chart of a method for remote control of an instrument 115 by multiple clients 105 as described in various representative embodiments. In FIG. 5, block 505 receives at least one communication 108 from each of at least two clients 105. Each of the received communications 108 conforms to the client specific protocol associated with the respective clients 105. Block 505 then transfers control to block 510.

In block 510, it is determined from which client 105 each received communication 108 was received. Block 510 then transfers control to block 515.

In block 515, it is determined for which application 110 resident on the instrument 115 that each received communication 108 is intended. There is at least one application 110 resident on the instrument 115. Block 515 then transfers control to block 520.

Block 520 transfers each received communication 108 to the intended application 110 for that received communication 108. Block 520 then terminates the process.

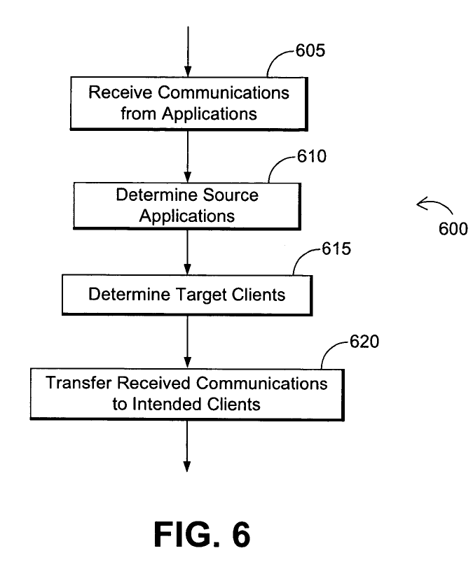

FIG. 6 is a drawing of a flow chart of another method for remote control of an instrument 115 by multiple clients 105 as described in various representative embodiments. In block 605, at least one communication 108 is obtained from at least one application 110 separately for each of at least two intended clients 105. Each obtained communication 108 conforms to the application specific protocol associated with the respective application 110. Block 605 then transfers control to block 610.

In block 610, it is determined from which application 110 each obtained communication 108 was obtained. Block 610 then transfers control to block 615.

In block 615, it is determined for which client 105 each obtained communication 108 is intended. Block 615 then transfers control to block 620.

Block 620 transfers the obtained communications 108 to the intended clients 105. Block 620 then terminates the process.

As previously noted, not all instruments use SCPI for their resident command language API's, and computers used in the control of instruments do not always use a SCPI command set. There are potentially several different command languages that the computer can communicate with an instrument. In addition to SCPI, a computer or system could use .NET which is an open software standard initially developed by Microsoft, Sun Microsystems' Java, CORBA which is a standard of the Object Management Group (OMG), or the like.

As is the case, in many data-processing products, the techniques for remote instrument 115 control by multiple clients 105 described herein may be implemented as a combination of hardware and software components. Moreover, the functionality needed for using such implementations may be embodied in computer-readable media, such as 3.5 inch floppy disks, conventional hard disks, DVD's, CD-ROM's, Flash ROM's, nonvolatile ROM, RAM and the like, to be used in programming an information-processing apparatus (e.g., a computer and/or instrument 115) to perform in accordance with these implementations.

The term “program storage medium” is broadly defined herein to include any kind of computer memory such as, but not limited to, floppy disks, conventional hard disks, DVD's, CD-ROM's, Flash ROM's, nonvolatile ROM, RAM, and the like.

Client 105 and developer computers, as well as instruments 115 used with the measurement system 100, can be capable of running one or more of any commercially available operating system such as DOS, various versions of Microsoft Windows (Windows 95, 98, Me, 2000, NT, XP, or the like), Apple's MAC OS X, UNIX, Linux, or other suitable operating system.

While the present invention has been described in detail in relation to representative embodiments thereof, the described embodiments have been presented by way of example and not by way of limitation. It will be understood by those skilled in the art that various changes may be made in the form and details of the described embodiments resulting in equivalent embodiment that remain within the scope of the appended claims.

1. A method for remotely controlling an instrument, comprising:
receiving at least one communication from each of at least two clients, wherein each received communication conforms to a client specific protocol;
determining from which client each received communication was received;
determining an application resident on the instrument for which each received communication is intended, wherein at least one application is resident on the instrument; and
transferring each received communication to the intended application.

2. The method as recited in claim 1, wherein the client specific protocol is the Standard Commands for Programmable Instrumentation (SCPI) protocol.

3. The method as recited in claim 1, wherein the communications from the clients are interpreted into an interpreted command usable by the application module.

4. The method as recited in claim 1, further comprising:
separately for each of at least two intended clients, obtaining at least one additional communication from at least one application, wherein each obtained additional communication conforms to an application specific protocol;
determining from which application each obtained additional communication was obtained;
determining for which client each obtained additional communication is intended; and
transferring each obtained additional communication to the intended client.

5. The method as recited in claim 4, wherein the application specific protocol is the Standard Commands for Programmable Instrumentation (SCPI) protocol.

6. The method as recited in claim 4, wherein the obtained additional communications are modified to produce client messages which are in appropriate format for the client.

7. The method as recited in claim 4, wherein at least one obtained additional communication is in response to one of the communications received from one of the at least two clients, wherein the application tracks from which client the received communication originated, and wherein the application uses that tracking information to direct the at least one obtained additional communication to the client from which the received communication originated.

8. A computer readable memory device embodying a computer program of instructions executable by the computer, the instructions comprising:
receiving at least one communication from each of at least two clients, wherein each received communication conforms to a client specific protocol;
determining from which client each received communication was received;
determining an application resident on the instrument for which each received communication is intended, wherein at least one application is resident on the instrument; and
transferring the received communication to the intended application.

9. The computer readable memory device as recited in claim 8, wherein the client specific protocol is the Standard Commands for Programmable Instrumentation (SCPI) protocol.

10. The computer readable memory device as recited in claim 8, wherein the communications from the clients are interpreted into an interpreted command usable by the application module.

11. The computer readable memory device as recited in claim 8, the instructions further comprising:
separately for each of at least two intended clients, obtaining at least one additional communication from at least one application, wherein each obtained additional communication conforms to an application specific protocol;
determining from which application each obtained additional communication was obtained;
determining for which client each obtained additional communication is intended; and
transferring each obtained additional communication to the intended client.

12. The computer readable memory device as recited in claim 11, wherein the application specific protocol is the Standard Commands for Programmable Instrumentation (SCPI) protocol.

13. The computer readable memory device as recited in claim 11, wherein the obtained additional communications are modified to produce client messages which are in appropriate format for the client.

14. The computer readable memory device as recited in claim 11, wherein at least one obtained additional communication is in response to one of the communications received from one of the at least two clients, wherein the application tracks from which client the received communication originated, and wherein the application uses that tracking information to direct the at least one obtained additional communication to the client from which the received communication originated.

15. An instrument, comprising:
at least two server logic modules, wherein each server logic module is configured to receive communications from separate client logic modules, wherein each received communication conforms to a client specific protocol of the client logic module from which the received communication was transmitted, and wherein each server logic module is configured to determine from which client the received communications were transmitted;
at least one interpreter logic module configured for formatting the received communications, wherein each server logic module is connected to and transfers its received communications to one of the interpreter logic modules and wherein each interpreter logic module is configured to format the received communications from the server logic modules to a format in which it its intended application can respond; and
at least one application module resident on the instrument, wherein each server logic module is configured to determine for which application each received communication is intended, and wherein each interpreter logic module is configured to transfer the interpreter logic module formatted communications to the intended application.

16. The instrument as recited in claim 15, wherein the interpreter further comprises a parser logic module, wherein the parser logic module is configured for parsing received communications, wherein each server logic module is connected to and transfers its received communications to one of the parser logic modules, and wherein each parser logic module is configured to parse the received communications from the server logic modules to which it is attached.

17. The instrument as recited in claim 16, wherein the interpreter further comprises a stream wrapper and wherein the stream wrapper modifies the communication to place it in a format more usable by the application.

18. The instrument as recited in claim 16, wherein the interpreter further comprises a semantics checker logic module and wherein the semantics checker logic module checks for the validity of various components of the communication.

19. The instrument as recited in claim 15, wherein the client specific protocol is the Standard Commands for Programmable Instrumentation (SCPI) protocol.

20. The instrument as recited in claim 15, wherein the application comprises a virtual instrument configured to receive the parsed received communications, wherein the application further comprises an application logic module configured to receive the parsed received communications from the virtual instrument, and wherein the application logic module is configured to perform actions in response to the parsed received communication.

21. The instrument as recited in claim 15, wherein the server is configured to send and receive communications via a connection selected from the group consisting of USB-488, a GPIB, and a IEEE 488 LAN.

22. The instrument as recited in claim 15, wherein each interpreter logic module is configured to receive communications from the application intended for the client associated with that interpreter logic module, to translate the communication received into an appropriate translated communication having the client specific protocol for the associated client, and to transfer that translated communication to the associated server logic module, wherein each server logic module is configured to receive communications from the interpreter logic module associated with that server logic module and to transmit the translated communications to the client associated with that server logic module, and wherein each server logic module which receives commands having client specific protocol the same as the application specific protocol of the intended application is configured to receive communications from that application and to transmit those communications to the client logic circuit associated with that server logic module.

23. The instrument as recited in claim 22, wherein the application is configured to respond as appropriate to communications received from clients, wherein the application is configured to track from which client the received communication originated, and wherein the application is configured to use that tracking information to direct the response communication to the client from which the received communication originated.
